(19) United States
(12) Patent Application Publication
(10) Pub. No.: US 2010/0146491 A1
(43) Pub. Date: Jun. 10, 2010

(54) System for Preparing Software Documentation in Natural Languages

(75) Inventors: Satoshi Hirano, Ibaraki (JP); Takeshi Ohkawa, Ibaraki (JP); Runtao Qu, Queensland (AU)

Correspondence Address: YOUNG BASILE, 3001 WEST BIG BEAVER ROAD, SUITE 624, TROY, MI, 48084, US

(73) Assignee: NATIONAL INSTITUTE OF ADVANCED INDUSTRIAL SCIENCE, Tokyo (JP)

(21) Appl. No.: 11/996,809

(22) PCT Filed: Jul. 25, 2006
(86) PCT No.: PCT/JP2006/314607

§ 371 Date: Jan. 25, 2008

(30) Foreign Application Priority Data
Jul. 28, 2005 (JP) 2005-218993

(51) Int. Cl. G06F 9/45

(52) U.S. Cl. 717/137

(57) ABSTRACT

A software documentation preparing system which can prepare software documentation written in plural natural languages is provided. The software documentation preparing system uses input unit for inputting a source file including a source code statement written in a programming language and a comment assigned to the source code statement, in which source file, the comment describing one of functions in the source code is described in plural natural languages, each of the descriptions in the natural languages provided with a combined sign of a sign indicating the function and a sign indicating a type of natural language; interprets the input source file, identifies the combined sign, associates the sign with a source code statement, and stores a comment on memory; extracts only a comment provided with a sign corresponding to the type of the user-specified natural language to be output; and outputs software documentation in the natural language to be output for the source code statement based on the extracted comment.

### TECHNICAL FIELD

The present invention relates to a software documentation preparing system capable of outputting software documentation in plural natural languages, and more specifically to a software documentation preparing system capable of preparing documentation on the software from a source file of computer software including comments in text processing, and converting a file in the text processing.

### BACKGROUND ART

Before describing the present invention, the definitions of terms that can be frequently misunderstood are first described below. In the present invention, some types of “languages” are used in a computer system. Therefore, in the present specification, a “natural language” means a language normally used by people such as Japanese, English, Chinese, Korean, etc. A “programming language” generally means a language such as an assembly language, a C language, a Java (registered trademark) language for describing software that operates information equipment.

It is an important strategy for a software house to deliver software products to a number of nations and areas. Generally when software is used, a user reads any documentation to fully understand the software. In this case, the user can learn how to use the software the most efficiently by reading the documentation written in the first natural language (that is, the mother tongue) of the user. That is, the usability of software largely depends on the readability of the documentation relating to the software. Therefore, presenting the documentation relating to software, or generally the documents relating to software, in a language of each nation or area allows the value of the software to be enhanced in each target area.

On the other hand, rapid progress has been made in international software development. A programming language itself is substantially independent of a natural language, and belongs to a knowledge system common to worldwide software developers. Therefore, the internationalization is a natural course of software development. However, as the software has been complicated these days, it is very difficult to understand the software only by the source codes of the software. As a result, it is common to share or distribute among developers the documents (examples: XXX software documentation, YYY internal program specification, etc.) relating to the development of software written in a natural language together with source codes. Some documents can promote the understanding of users relating to the specification of the software. The problem is the natural language in which a developing document is written.

Generally, a document for development is frequently described in the first natural language in a target area, or in English as an internationally standard natural language in many cases. However, there are very few persons having the ability to fully understand the necessary language and successfully develop software. Therefore, it would be helpful to deeply understand the software to be developed by reading the software developing document in the mother tongue of the reader (that is, a software developer) in order to significantly reduce development time. Therefore, it is desired that a software product (or a software component product) is released not only along with a document in English as an internationally common natural language, but also with a document written in a local natural language. As a result, the value of the software product can be enhanced in each area of the world.

Therefore, it is necessary to prepare a document written in some natural languages on the software developing side. However, it takes a long time and much labor to prepare a document for software development. Especially when it is necessary to issue a document in a large number of natural languages, it is necessary to provide a translating step for each issue, and a step of confirming the consistency among the documents written in the respective natural languages, thereby causing the bottleneck in improving the productivity of a software product.

The above-mentioned problems can be easily understood by considering the step of preparing a software developing document as associated with the software itself. Generally, it is costly to separately prepare and maintain a source code and a software developing document (internal specification) of software because internal specification is a document closely related to a source code of software, and it is hard to maintain the consistency in contents between the source code and the document when changes are needed in the source code.

Therefore, it has been widely recognized that a mode of development, in which operable software is integrated with the document by annotating (with comments) the source code of software, is effective in improving the productivity of software products. For example, in the document “Literate Programming”, Knuth shows software in a programming language written along with the description in a natural language by incorporating the source code of software into text, and demonstrates the effectiveness of the mode of development. In the mode of development, a comment in the source code is automatically extracted and adjusted by the comment extracting and document adjusting software, and can be immediately available during software development or operation as a complete document.

It is appropriate to say that an automatic document preparing system is very effective from the viewpoint of the quality maintenance and cost reduction for software and a document. Furthermore, since the document can be immediately available, it is effective in improving the development efficiency. In addition, it has the advantage that the consistency between the software to be executed and the document can be easily guaranteed.

Javadoc of Sun Microsystems, Inc. is an appropriate example of the system. In a program source code of Java (registered trademark), a description is written as a comment in a component of software such as a class, a method, etc. so that a document can be output as an HTML document and a PDF document. When a description is written, a sign indicating the meaning of the description can be added to the description, thereby controlling the description such that the description can be displayed in an appropriate position in the document to be output.

Such an automatic preparation of a document has traditionally been implemented on a source file having a comment written in a single natural language, because it is a common practice to describe software in a programming language using an English character set and a comment added to the source file is also written in English in many cases, due to the history of the establishment of a computer and the background that the internationally standard and natural language is currently English.

Outstanding open implementation of preparing a document similar to Javadoc as a system of automatically preparing a document from a software source code can be a Doxygen, KDOC, DOC++, etc. However, the listed tools are to prepare software documentation written in a single natural language.

A well-known technique of a contents filter for an electronic document written in plural foreign languages is the patent document 1. The technique of a contents filter is to classify news articles of mainly current events into the respective fields of topics.
Patent Document 1: U.S. Pat. No. 6,542,888 as Specifications

### DISCLOSURE OF THE INVENTION

Conventionally, as described in the patent document 1 as a technique of preparing software documentation in plural natural languages, there is a technique of a contents filter for an electronic document written in plural foreign languages. However, the technique is to classify news articles of mainly current events into the respective fields of topics, but is not to explicitly and concretely indicate a method of classifying and extracting a statement written in plural natural languages. Therefore, it does not indicate a system of preparing software documentation in plural natural languages by applying the technique to a source file of software.

In addition, there is a method of using a text preprocessing system as a well-known technique. Concretely, a document preprocessing system is, for example, a preprocessor for a C language. An assumed method is, for example, embedding an instruction for a preprocessor in a source file on a preparing side, and performing a preprocess before inputting the instruction to an automatically document preparing system, thereby removing a comment written in the languages other than the natural language to be used in preparing a document, and preparing software documentation described in the target natural language. An example of an instruction for a C language preprocessor can be #ifdef, #endif, etc., and a purpose can be attained by fully utilizing the instructions. However, since the description is complicated, and it is originally used in describing a source code of software, there can be a disorder frequently occurring in the management of codes for identifying a language, and they are not appropriate for identifying a comment in plural natural languages.

At present, there is no effective technique of enhancing the productivity in preparing software documentation written in plural natural languages. Therefore, the present invention aims at providing a system for preparing software documentation in plural natural languages to prepare software documentation written in plural natural languages.

To attain the above-mentioned objectives, the system for preparing software documentation in plural natural languages according to the present invention as the first aspect includes: input means for inputting a source file including a source code statement written in a programming language and a comment assigned to the source code statement, in which source file, the comment describing one of functions in the source code is described in plural natural languages, each of the descriptions in the natural languages provided with a combined sign of a sign indicating the function and a sign indicating a type of natural language; storage means for interpreting the input source file, identifying the combined sign, associating the sign with a source code statement, and storing a comment on memory; extraction means for extracting only a comment provided with a sign corresponding to the type of the user-specified natural language to be output; and output means for outputting software documentation in the natural language to be output for the source code statement based on the extracted comment.

The system for preparing software documentation in plural natural languages according to the present invention as the second aspect includes: input means for inputting a source file including a source code statement written in a programming language and a comment assigned to the source code statement, in which source file, the comment describing one of functions in the source code is described in plural natural languages, each of the descriptions in the natural languages provided with a combined sign of a sign indicating the function, a sign indicating a type of natural language, and a sign indicating a nation or an area; storage means for interpreting the input source file, identifying the combined sign, associating the sign with a source code statement, and storing a comment on memory; extraction means for extracting only a comment provided with a sign corresponding to the type of the user-specified natural language to be output; and output means for outputting software documentation in the natural language to be output for the source code statement based on the extracted comment.

In this case, the software documentation preparing system further includes translation means for translating a statement in one natural language into a statement in another natural language. When there is no comment provided with a sign corresponding to the type of the user-specified natural language to be output specified by a user, the extraction means extracts a comment provided with a sign corresponding to the type of a predetermined natural language from the source file, and the output means allows the translation means to perform machine translation based on the comment to be output described in the natural language to a comment described in predetermined language, and outputs software documentation in the user-specified natural language to be output.

In this case, the system can also be configured such that a sign indicating the type of a primary natural language can be included in a source file to indicate the default of the type of the natural language of a comment to be translated when the machine translation is performed.

The system can also be configured such that, in the software documentation preparing system according to the present invention, a sign added to a comment includes a sign showing the necessity to update a comment, and the output means can output the information about a portion to be updated or a language to be updated in a source file based on a sign showing that the comment is necessary to be updated. According to another aspect of the present invention, each process element (means) is realized as a program. When the program is installed in the information processing device, it functions as the software documentation preparing system according to the present invention. In this case, there is a characteristic in the data structure for configuring a source file structure used in the system. In a source file including a source code statement written in a programming language and a comment assigned to the source code statement, a comment describing a function in a source code is described in plural natural languages, and a sign of a combination of a sign of a function and a sign of the type of a natural language is provided for a description of each natural language. In another source file including a source code statement written in a programming language and a comment assigned to the source code statement, a comment describing a function in a source code is described in plural natural languages following the sign indicating a function, and a sign of the type of the natural language used in the description is added to the comment.

According to the software documentation preparing system of the present invention with the above-mentioned configuration, by including a comment written in plural natural languages in a source file together with a source code, a software developer, an editor of each language, and a translator of each language can be prevented from performing a wrong editing process. Simultaneously, a portion necessary to be translated, such as a comment described in a foreign language can be displayed to a translator, thereby efficiently performing the editing process. As a result, the following problems can be successfully solved.

(Problem 1): Conventionally, a software developer prepares a source file provided with a comment for a source code written in a programming language, and prepares software documentation using a tool such as Javadoc etc. for preparing software documentation by inputting the source file. However, those tools are used for a single natural language. Therefore, it is necessary to translate a file in each natural language and confirm the consistency at a request for software documentation written in plural natural languages, and a comment written in plural natural languages has not been held in the source file for future processing. On the other hand, according to the software documentation preparing system of the present invention, a system capable of describing a comment of a source file in plural natural languages, and preparing software documentation written in plural natural languages can be realized.

(Problem 2): Although a natural language does not one-to-one correspond to a nation or an area, it is necessary to provide appropriate software documentation at a user request. However, no system for satisfying the request has been realized. The problem can also be solved by the software documentation preparing system according to the present invention.

(Problem 3): In a source file including a source code written in a programming language and a comment written in a natural language, the method of appropriately determining a portion to be translated has not been clearly described, and it is necessary to perform translation by a human translator, not by a machine translation. Therefore, in the process of manufacturing a software product, a long time and a high cost are required to prepare software documentation. The problem can also be solved by the software documentation preparing system of the present invention.

(Problem 4): Although in the case where machine translation can be applied to a comment in a source file, it is difficult to appropriately select a comment to be translated, and explicit selection means for reflecting an intention of a software developer is required. According to the software documentation preparing system of the present invention, the problem can also be solved.

(Problem 5): Although there are a describing method and a system for a processing method for a source file described by a comment in plural natural languages, it is very difficult to appropriately change and manage the contents of a comment written in each natural language based on the specification change of software and the implementation contents of a source code. For example, when a comment described in a natural language is changed, the changed comment does not match a comment described in another natural language, but it is difficult to manage the information as to which comment is to be amended as the latest information. Up to now, no system has been realized for appropriately changing and managing a source file for which a comment has been written in plural natural languages. According to the software documentation preparing system of the present invention, the problem can also be solved.

### BRIEF DESCRIPTION OF THE DRAWINGS

FIG. 1 shows the outline of the documentation preparing system according to the present invention;

FIG. 2 shows an input source file having a comment in plural natural languages;

FIG. 3 shows an example of an input source file which is provided with a comment in plural natural languages and whose target nation or area is specified;

FIG. 4 shows the outline of the procedure of preparing documentation;

FIG. 5 shows the outline of another procedure of preparing documentation;

FIG. 6 shows the procedure of preparing documentation including machine translation;

FIG. 7 shows the procedure of preparing documentation including machine translation using a sign for determination of the type of a primary natural language;

FIG. 8 shows an input source file including a sign indicating a portion to be updated;

FIG. 9 shows the procedure of preparing documentation for which a portion to be updated can be confirmed;

FIG. 10 shows an example (XML and CSV) of the format of a comment;

FIG. 11 shows the outline of an electronic file conversion system;

FIG. 12 shows an example of outputting documentation written in English;

FIG. 13 shows an example of outputting documentation written in Japanese;

FIG. 14 shows an example of an input source file including a sign indicating a primary natural language; and

FIG. 15 shows another example of a source file structure.

### BEST MODE FOR CARRYING OUT THE INVENTION

The mode for embodying the present invention is described below with reference to a concrete embodiment. In the description of the embodiment, the software documentation preparing system is operated by realizing a system element that functions as processing means by installing software (program) executed on a computer (or information equipment in a broad concept). As a file in this system, an electronic file stored in the storage device of a computer is assumed. The software documentation preparing system can also be configured as a stand-alone software documentation preparing apparatus most parts of which are configured by hardware and maintain the same functions.

In a source file input to the software documentation preparing system, not only a source code statement written in a programming language described in developing a program, but also a comment assigned and corresponding to the source code statement is input. The comments are described as necessary explanation in the necessary number of types of natural languages more than one. In this case, signs indicating the meanings of comments describing the functions of a source code and the types of natural languages are assigned as follows.

In a source file input to a normal software documentation preparing system, a comment is provided with a sign indicating the meaning of a comment. Normally, a comment is identified by a sign indicating the meaning by performing a syntax analysis on an input source file, and is stored in the storage means. However, in a source file to be targeted by the present invention, a comment written in each natural language is described in plural natural languages. Therefore, a sign obtained as a combination of a sign indicating the type of a natural language of each comment and a sign indicating the meaning of the comment is assigned, and these signs are described together. Therefore, when a comment is stored, it is identified by a sign as a combination of a sign indicating the type of a natural language and a sign indicating the meaning of the comment, and then stored.

In the software documentation preparing system, as described above, only a comment assigned a sign corresponding to the type of a user-specified natural language to be output is extracted from the comment identified by a combination sign and stored in the storage means. Thus, the software documentation corresponding to the source code statement and the executable software can be output in a specified natural language to be output.

In the software documentation preparing system, not only a sign as a combination of a sign indicating the type of a natural language, a sign indicating the meaning of a comment, but also a sign indicating a nation or an area is assigned to each comment written in each natural language in an input source file, and a comment including the sign is extracted to output software documentation.

Also in the software documentation preparing system, a comment of a specified natural language can be prepared by machine translation based on the comment described in another natural language to output software documentation, but a comment is prepared by including a sign indicating the type of a primary natural language in an input source file and performing machine translation of specified natural language comment based on the indicated primary natural language, thereby output software documentation.

Furthermore, a comment can also include a sign as a combination of a sign requiring update as assigned to a source code statement in an input source file, and the information about a portion requiring update by interpreting the comment including the sign can also be output.

It is also effective to provide a system that converts a source file that can be input to an existing software documentation preparing system. That is, the software documentation described in a target natural language is not prepared directly from the source file written in plural languages, but first a source file having a comment in the target natural language is output by extracting only a comment described in the target natural language and a source code. Then, the output source file is input to an existing documentation preparing system, thereby obtaining a software documentation finally described in a target natural language. This also provides an effective system.

In an example of a source code shown in the attached drawings, the description in the Java (registered trademark) language is illustrated, but the software documentation preparing system according to the present invention is not applied only to a software source code described in the Java (registered trademark) language. That is, the system can be applied not only in the Java (registered trademark) but also in any programming language.

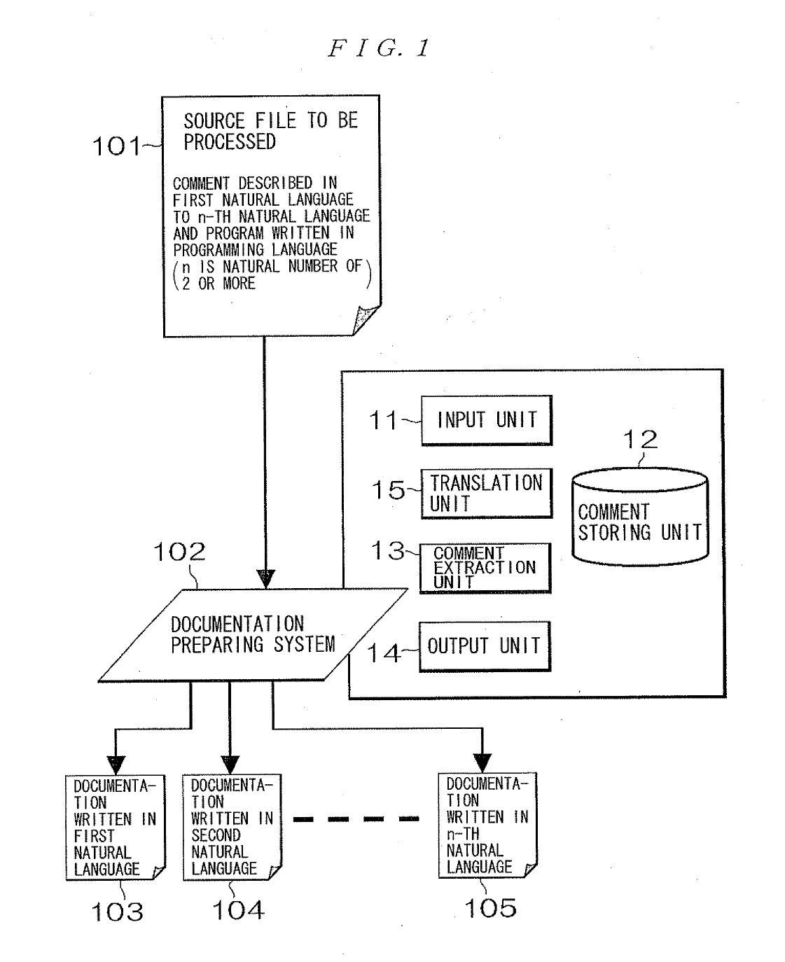

FIG. 1 shows the configuration of a system in which software documentation written in plural natural languages is prepared from a single program source file. A source file 101 in the system is a source file to be processed including a comment described in the first to the n-th natural languages (n is a natural number of 2 or more) and a software program written in a programming language.

The software documentation preparing system according to an embodiment of the present invention includes as system elements, as shown in FIG. 1, an input unit 11, a comment storing unit 12, a comment extraction unit 13, an output unit 14, and a translation unit 15. A documentation preparing system 102 is configured by the comment extraction unit 13, the output unit 14, the translation unit 15, and a control processing unit not shown in the attached drawings.

The input unit 11 inputs a source file including a source code statement written in a programming language and a comment assigned to the source code statement. That is, in a source file including a source code statement written in a programming language and a comment assigned to the source code statement, a comment describing a function in a source code is described in plural natural languages, and the data structure of the source file 101 input by the input unit 11 is provided with a sign of a combination of a sign indicating a function and a sign indicating the type of a natural language in the description of each natural language. The comment storing unit 12 stores a source file after performing a syntactic analysis the source file by associating an input comment with a source code statement. In this case, for example, a comment written in two or more types of natural languages is identified for each comment written in each natural language by a sign (for example, @u.ja etc.) as a combination of a sign indicating the type of the natural language and a sign indicating the meaning of the comment and stored. The comment extraction unit 13 extracts only the comment provided with a sign (for example, ja etc.) corresponding to the type of the user-specified natural language to be output from the comment storing unit 12. The output unit 14 outputs software documentation in a natural language to be output for the source code statement based on the extracted comment. The translation unit 15 performs machine translation on a statement in one natural language into a statement in another natural language as described later.

A source file input from a user by the input unit 11, or the source file 101 including a comment stored in the comment storing unit 12 is input to the documentation preparing system 102. A user specifies the type of a natural language of the software documentation to be output to the documentation preparing system 102. The documentation preparing system 102 allows the comment extraction unit 13 to extract only a comment provided with a sign corresponding to the specified type of a natural language to be output, thereby allowing the output unit 14 to output the software documentation corresponding to the source code statement and the executable software in the natural language to be output.

When a user specifies the first natural language to the documentation preparing system 102, documentation 103 written in the first natural language is output. When the user specifies the second natural language, documentation 104 written in the second natural language is output. When the user specifies the n-th natural language, documentation 105 written in the n-th natural language is output. The number of the types of the specified natural languages in this case can be only one or more than one simultaneously specified.

Thus, the system extracts a comment written in a target natural language from a comment written in a source code in plural types of natural languages, and automatically prepares a document in a target natural language from a source file.

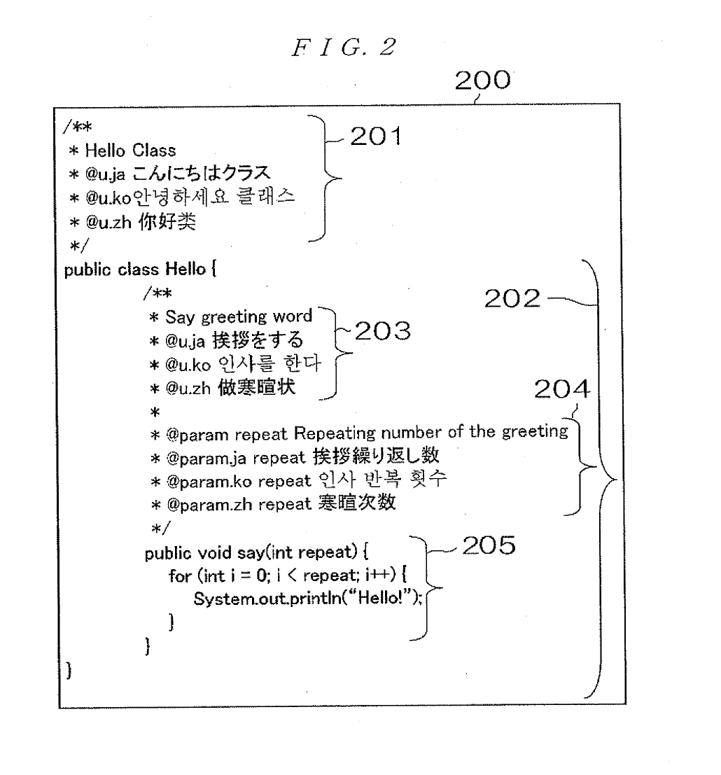

FIG. 2 illustrates the details of an input source file to be processed. As shown in FIG. 2, a source file 200 holds a comment written in each natural language with the source code of a program on a single source file. In this case, a character code system in which the text in multiple natural languages is stored on a single electronic file is used in the source file 200. In the embodiment, a Unicode character set (ISO 10646) is used. A UTF-8 (RFC 3269) is used as a character coding system. However, any character set that can represent a statement written in multiple natural languages and any character coding system can be applied to the present invention.

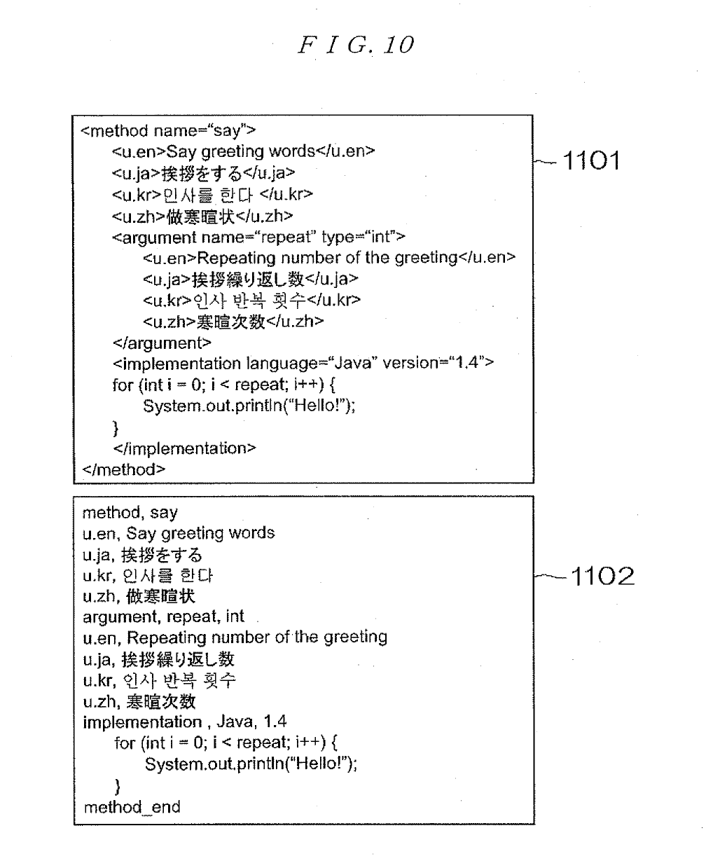

FIG. 2 shows an example of a method of describing in a source file a sign identifying a comment for which natural language is written. In a programming language such as Java (registered trademark), the area enclosed by “/*” and “*/” is processed as a comment not as an original program source code. In this example, a comment starts with “/**”, which is called a document comment, and is treated separately from a normal comment. A document comment is interpreted and output by a software documentation preparing system such as Javadoc etc. Software documentation is output based on the contents of the document comment. In an example of an input source code in the embodiment, a comment format in accordance with Javadoc is used, but another comment format, a program source code description format, for example, a comment program source code description using the XML can be applied to the present invention. Examples of other description formats are shown in FIG. 10.

Examples of description formats shown in FIG. 10 are examples of an XML file format and a CSV file format. A source file 1101 shown at the upper portion of FIG. 10 holds a comment described by a source code and in plural natural language in the XML file format in a single file. A source file 1102 holds similar contents in a CSV format (comma separated values) file. Otherwise, similar applications can be realized in a large number of similar formats. In an application of the source file 1101 to the XML format, for example, the sign <u. en> can be modified to a sign described as <u lang=“en” using, as an XML attribute, the symbol “en” indicating a natural language. The sign can indicate similar effect as an embodiment of a combination sign.

Back to FIG. 2, in the source file 200 shown in FIG. 2, a document comment 201 shown prior to a definition statement 202 of a “Hello class” describes the general description of the class. A “@u.ja” tag is shown as a sign that indicates that the text following the tag of the sign is a general description of the class written in Japanese. A “@u.ko” tag as another type of sign is shown to indicate that the text following the tag is the general description of the class written in Korean. Similarly, a “@u.zh” tag as a sign of another type indicates that the text following the tag is the general description of the class written in Chinese.

The sign “@u” is defined as a tag indicating the general description of a comment, and is a sign indicating the meaning of a comment. The following sign “.ja”, “.ko”, “.zh” indicates the type of a natural language to be used. These signs can be combined and the combination sign “@u.ja” is obtained by combining a “sign indicating the meaning of a comment” and a “sign indicating the type of natural language”, and the sign simultaneously represents the meaning of a comment and the type of natural language.

In the present invention, by using the above-mentioned combination sign, the documentation of plural types of natural languages can be efficiently edited and prepared. During editing a source code, a programmer who develops a program uses these signs, thereby presenting a comment written in plural different types of natural languages.

Described next as another example of using the signs is a document comment assigned to a definition 205 of a method “say”. A first half portion 203 is similar to the comment assigned to a class, and describes the outline of the method. A “@param” tag of the sign is assigned before the comment for description of the argument of the method in Javadoc. The sign is also a “sign indicating the meaning of a comment”. In this case, to correspond to plural types of natural languages, a sign indicating the type of a natural language is combined with a “@param” tag, and a resultant combination sign is used. That is, using a “@param.ja (Japanese)” tag, a “@param.ko (Korean)” tag, and a “@param.zh (Chinese)” tag as combination signs in a comment 204, combination sign corresponding to plural types of natural languages are generated. Using the tags, a documentation preparing system can identify each comment as a description of an argument of the method, and as a comment for each natural language.

An ISO 639 is regulated as an international standard of the name of a natural language, an ISO 639-1 is regulated for representation by two alphabetical characters, and an ISO 639-2 is regulated for representation by three alphabetical characters. In this embodiment, the ISO 639-1 is used, but any appropriate natural language name can be regulated for use in the software documentation preparing system according to the present invention without limit to the ISO standards. By adopting the above-mentioned notation, the software documentation preparing system according to the present invention can extract only the comment relating to the natural language to be prepared.

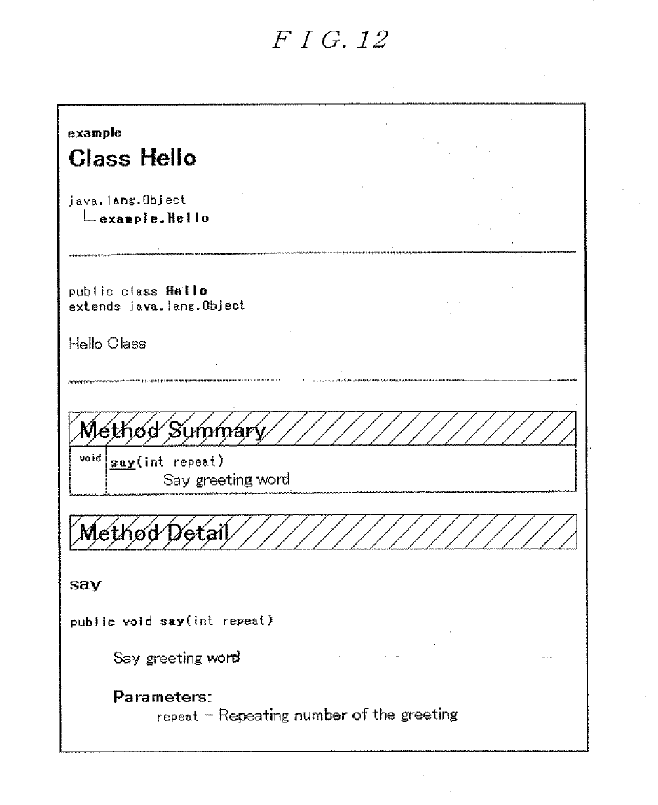

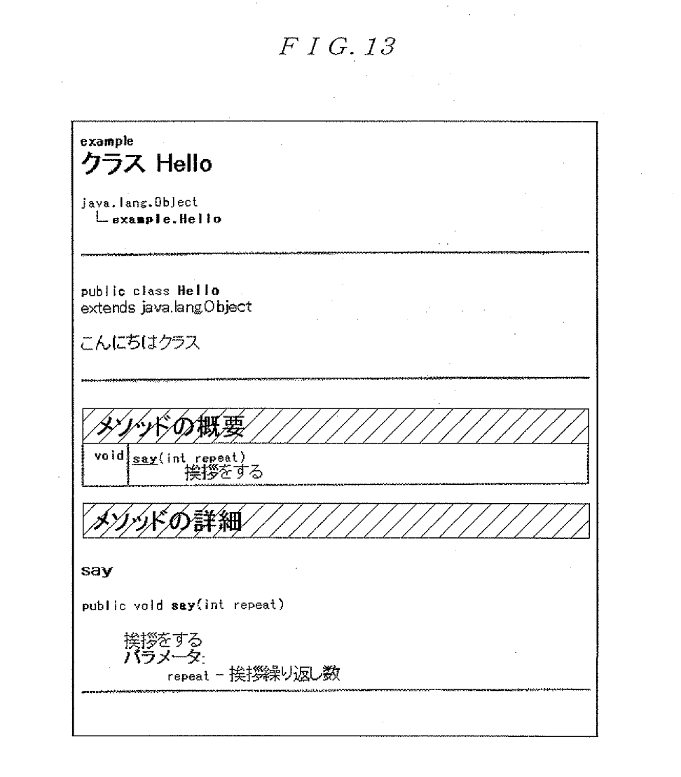

FIG. 12 shows an example of outputting documentation when a source file of FIG. 2 is used as an input and a language to be output is English (en). Javadoc is used as an existing documentation preparing system for use in preparing documentation. FIG. 13 shows an example of outputting documentation when a source file shown in FIG. 2 is used as input, and a language to be output is Japanese (ja). In each example, the description of a corresponding language is extracted and output from a comment in a source file.

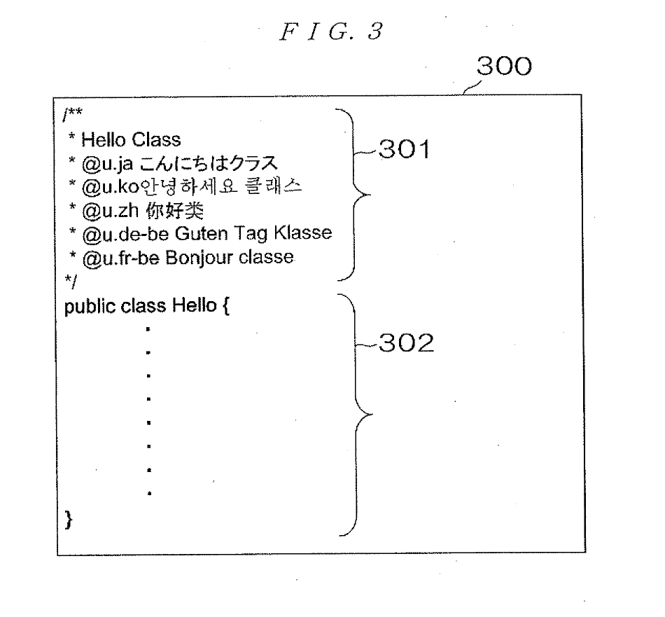

FIG. 3 shows an example of an input source file provided with a comment in plural natural languages and specified with a target nation or area. The input source file shown in FIG. 3 is provided with a comment in plural natural languages, and includes a comment specified by a target nation or area. As a sign added to the comments, a nation code is further combined and used in addition to the natural language code as shown in FIG. 3. Thus, target natural language and nation can be simultaneously specified.

In a source file 300 shown in FIG. 3, a document comment 301 assigned to a definition 302 of the “Hello class” includes a “@u.de-be” tag and a “@u.fr-be” tag of a combination sign, but the “@u.de-be” tag is used to describe a method argument, and indicates that the comment is issued to a person using German as the first natural language in the Kingdom of Belgium. In addition, “@u.fr-be” indicates that the type of a target natural language is not Germany but French.

With the above-mentioned example, a sign (nation code) indicating the type of a nation in addition to the sign (language code) indicating the type of natural language is further combined and used, thereby obtaining a sign for specifying a target natural language and nation. Therefore, a document can be written in more detail by a sign added to a comment corresponding to a source code.

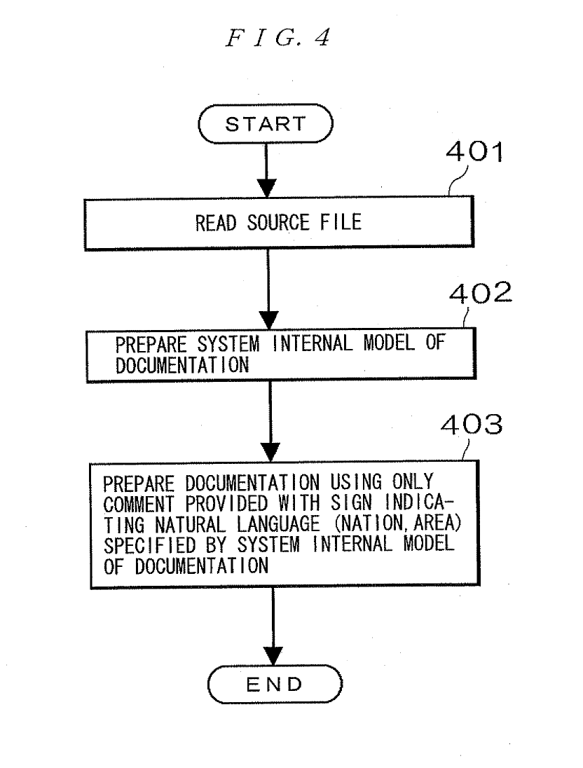

FIG. 4 is a flowchart for explanation of the process of preparing software documentation from an input source file. FIG. 4 shows how the documentation preparing process is performed when there is an above-mentioned input source file. The documentation preparing system 102 first reads a source file (step 401). After the reading process (or in parallel with the process), a system internal model of documentation is prepared (step 402). A system internal model of documentation represents the structure of the documentation on the memory of a computer for performing the process. The process is common to a number of documentation preparing systems. Although detailed description is omitted, but a characteristic point of the present invention is to extract a comment provided with a sign indicating a natural language (nation, area) specified by the system internal model of the documentation, and prepare the documentation using only the extracted comment (step 403). Thus, a document for each nation and area can be output based on the specification of a user.

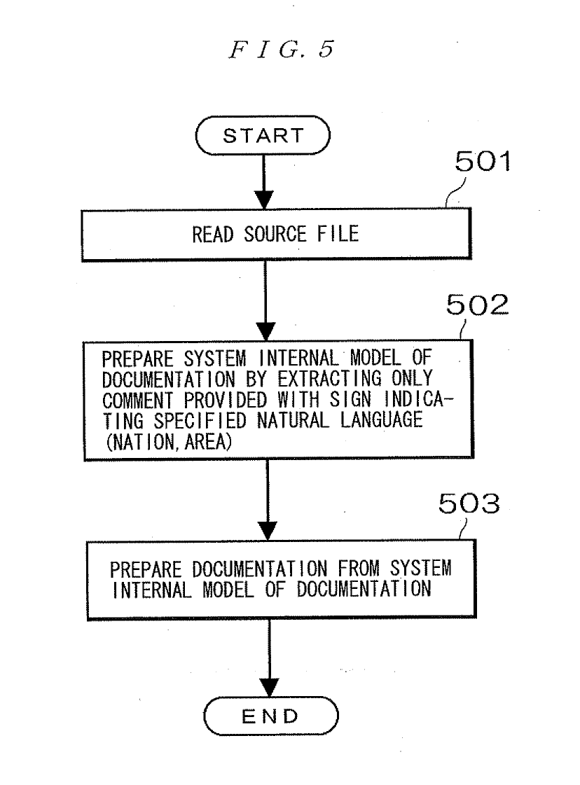

FIG. 5 is a flowchart for explanation of another example of a process of preparing software documentation from a source file. In the procedure of the documentation preparing process in this example, a source file is read (step 501), and when a system internal model of documentation is prepared (step 502), only necessary information (document comment) is fetched. At this time, a document comment relating to a natural language not specified by a user is filtered out. Therefore, the process (step 503) of preparing documentation to be output from the system internal model of documentation can be the same process as a conventional software documentation preparing system.

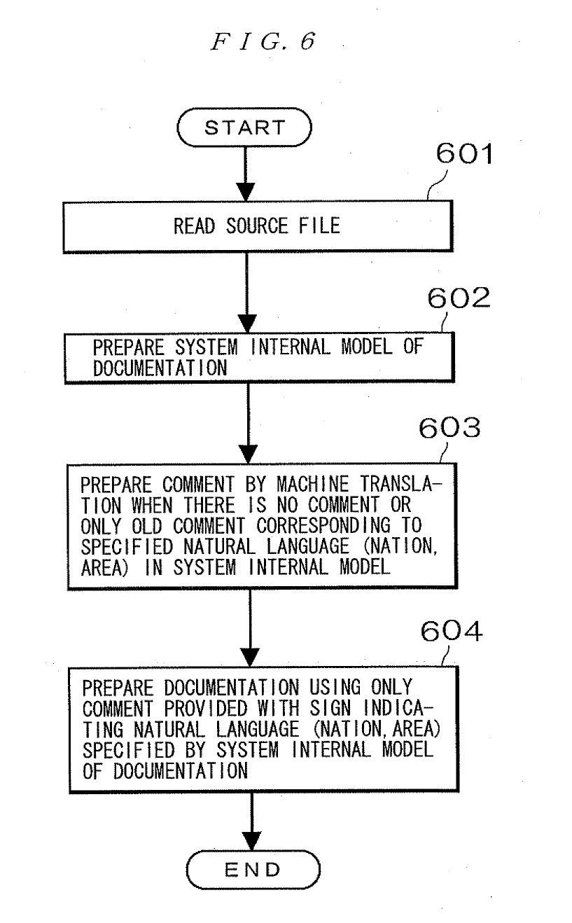

FIG. 6 is a flowchart for explanation of another example of the process of preparing software documentation from a source file. The example of the process shows the procedure of the documentation preparing process including machine translation. The documentation preparing system first reads a source file (step 601). After the reading process, a system internal model of documentation is prepared (step 602). When there is no comment corresponding to a specified natural language (nation, area) in the prepared system internal model, or the comment is very old, a comment is prepared by machine translation (step 603). Then, documentation is prepared (step 604) using only a comment provided with a sign indicating a natural language (nation, area) specified by a system internal model of documentation. Thus, depending on the specification of a user, a document for each nation and area can be output. In the procedure shown in FIG. 6, step 402 shown in FIG. 4 corresponds to step 602, and step 403 corresponds to step 604. Between steps 602 and 604, the process in step 603 is inserted. In the process in step 603, a preparing process is performed by machine translation when there are no or old comments for corresponding and specified natural languages (nations, areas) in the system internal model of documentation.

It is an outstanding advantage that, by performing the above-mentioned processes, the documentation of a necessary and natural language can be prepared without translation by a person. The machine translation is in other words, electronic translation, computer translation, etc. that a translating process is performed in a machine translation process without translation by a person. When there is low reliability in correctness and validity of a translated statement obtained by the machine translation, it is desired that the translated statement is provided with a sign indicating that the statement is obtained by the machine translation. Using the sign, the machine translated statement can be checked later.

It is not always necessary to include in a system the system element (machine translating module) for performing the machine translating process. Not only processing by using internal data representation, but also a process of using a software service outside a system using an external file or clip board can be performed. In addition, the system can be configured by adding the function of machine translation by using the framework of an OLE (object linking and embedding).

An important point of developing a program using a source code including a comment written in plural types of natural languages using the software documentation preparing system according to the present invention is how to practically prepare a source file including a comment written in plural types of natural languages when a source file is prepared.

For example, in a common development model without using the software documentation preparing system according to the present invention, the software designed by a software designer is realized as in a form of a source file by software implementers. At that time, a natural language of a comment assigned to a source code is a first natural language regulated in a current project. The first comment is normally described in the first natural language.

However, using the software documentation preparing system according to the present invention, a primary natural language can be set for each source file, and translating operations in a source code can be performed completely separately. Therefore, it is not always necessary to use the same natural language in each project. As a result, a natural language that can be easily understood by a member of a project and in which an operation can be efficiently performed can be selected, thereby efficiently performing the entire operation.

In the above-mentioned translating operation, it is also important to select the optimum language as an original natural language from which the translating operation is performed. A determining method can be 1. specified by a user, 2. a natural language to be used in a working environment of a user is specified as an original natural language, etc.

However, there are many cases in which each source file, class, or method is developed by a different developer. In this case, it is desired to provide the information for a documentation preparing system by including a sign indicating the type of a primary natural language in the source file.

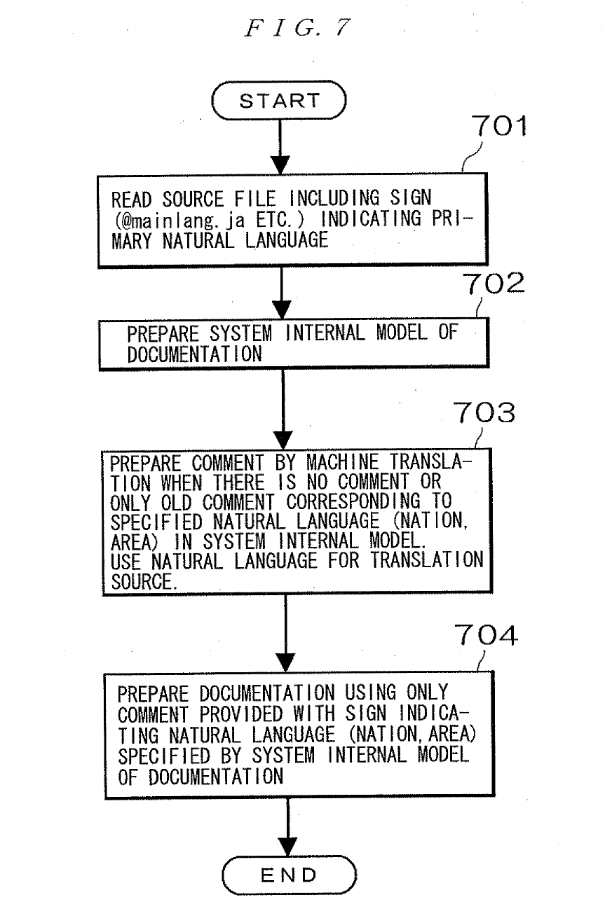

FIG. 7 shows the procedure of a documentation preparing process including the machine translation using a sign for definition of the type of a primary natural language. In this process, a source file including a sign indicating a primary natural language is read in step 701. In the next step 702, an internal model is prepared. In step 703, if there is no comment or only an old comment corresponding to a specified natural language (nation, area) in the internal model, then a comment is prepared by machine translation. As a natural language to be translated a primary natural language is used. In the process in the next step 704, documentation is prepared as described above.

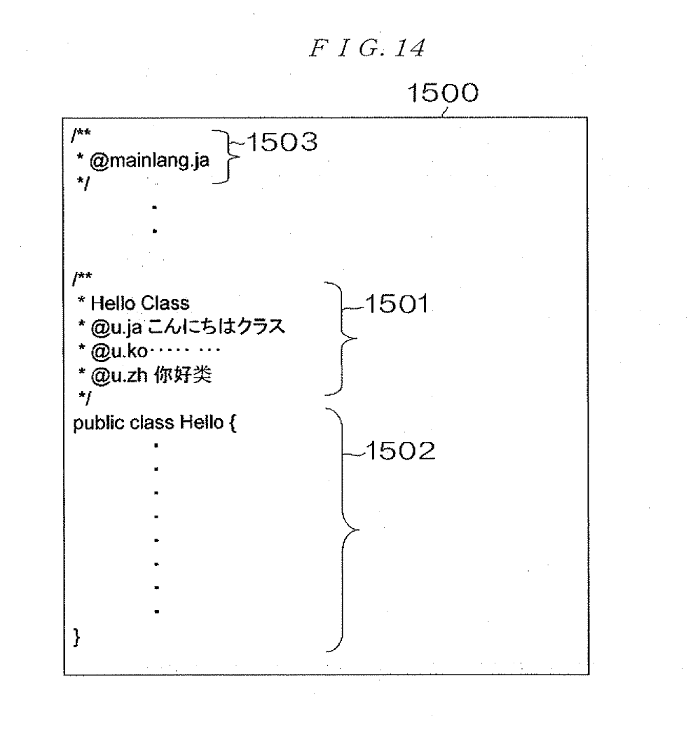

FIG. 14 shows an example of an input source file including the sign indicating a primary natural language. In a header portion 1503 of a source file 1500, “@mainlang.ja” is included in the comment, and means that Japanese is used as a primary natural language. For example, assume that the software documentation in Germany, which is not described in a comment of the source file 1500, is to be output. When a user of the system does not specify a language to be translated, and there is no sign existing, it is not certain which is to be selected for a comment portion 1501 in the plural natural languages, Japanese, Korean, or Chinese, to be translated from. In this case, since there is “@mainlang.ja” in the header portion 1503, it is certain that a Japanese comment indicated by “@u.ja” as a default can be selected as a comment to be translated. As a result, the documentation preparing system can obtain an appropriate comment by performing machine translation based on the indicated primary natural language, and software documentation can be output, thereby simplifying allocation of translation operations.

In the software documentation preparing system according to the present invention, it is important to maintain the consistency of the meaning among the comments written in each natural language in an input source file.

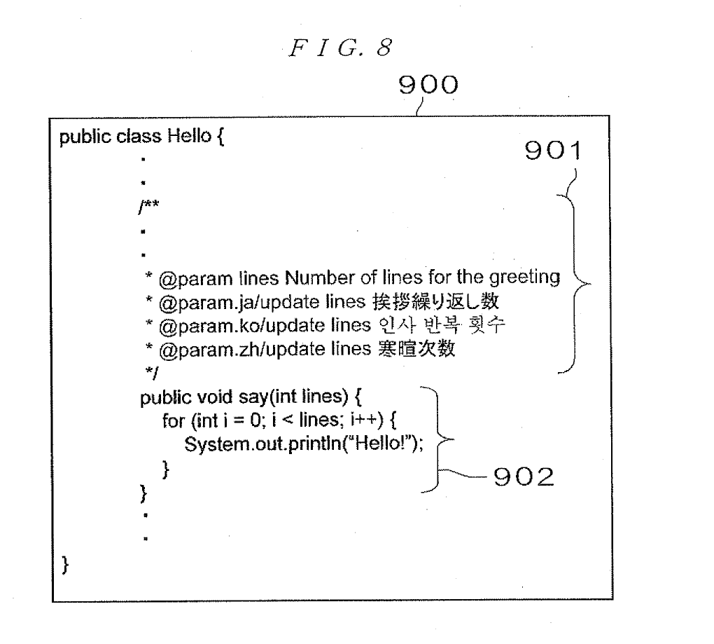

FIG. 8 shows an example of an input source file including a sign indicating a portion to be updated for a comment written in each natural language. An example of a source file shown in FIG. 8 indicates the definition of the entire “Hello class” in which a comment 901 is assigned to a definition 902 of the method “say”. The definition 902 is changed when the specification of the software is changed, or there is an amendment to the comment 901. These events often occur during the software development. An example of a source file shown in FIG. 8 indicates the situation in which the name of the argument of the “say” method is changed from “repeat” to “lines” in the source file shown in FIG. 2. Listed below is the order of a source code editing operation.
(1) The “say (int repeat)” is changed into “say (int lines)”.
(2) As a result, “@param repeat Repeating number of the greeting” is changed into “@param lines Number of lines for the greeting”, thereby changing the contents of the comment written in English.
(3) The contents of the comment in English are changed, but the editor cannot read or write a natural language other than English. Therefore, for other natural languages, a sign “/update” is added after the tag “@param.ja” etc., thereby describing “@param.ja/update”.

By performing the above-mentioned editing operation, it is determined as to whether or not it is necessary to at least perform again the translation on other natural languages other than English. By using the method, the consistency of the meaning can be easily maintained among the comments written in each natural language.

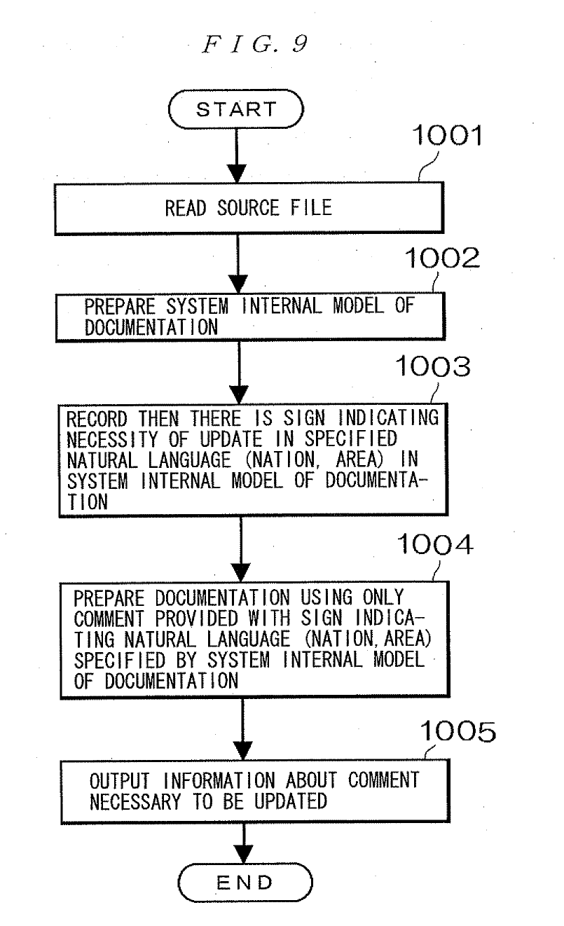

FIG. 9 shows the procedure of the documentation preparing process in which a portion to be updated can be confirmed in the software documentation preparing system according to the present invention. In the procedure, as described above, a source file is read in step 1001, and a system internal model is prepared in step 1002. In the next step 1003, in addition to the procedure shown in FIG. 4, a process of recording data is added when there is a “sign indicating the necessity to update a comment” in a specified natural language (nation, area) in the system internal model. In step 1004, documentation is prepared as described above. However, in the next step 1005, the information about the comment portion to be updated, or which is the natural language to be updated is output based on the information recorded in the entire steps. In the software documentation preparing system according to the present invention, a user can completely separately perform the translating operation based on the information.

In the software documentation preparing system according to the present invention, since the essential point is to assign a sign indicating the necessity to update a comment, the scope of the application of the present invention is not limited to an example illustrated in the present embodiment.

The software documentation preparing system according to the present invention can be embodied as a software documentation preparing system, apparatus, or method described in a target natural language directly by the respective means described above, but it is not always necessary to use the embodiment of directly preparing the documentation. By extracting only a comment described in a target natural language from a comment described in plural types of natural languages, an embodiment of converting an electronic file to output a source file provided with a comment in a single natural language can also be an effective implementation of the software documentation preparing system according to the present invention.

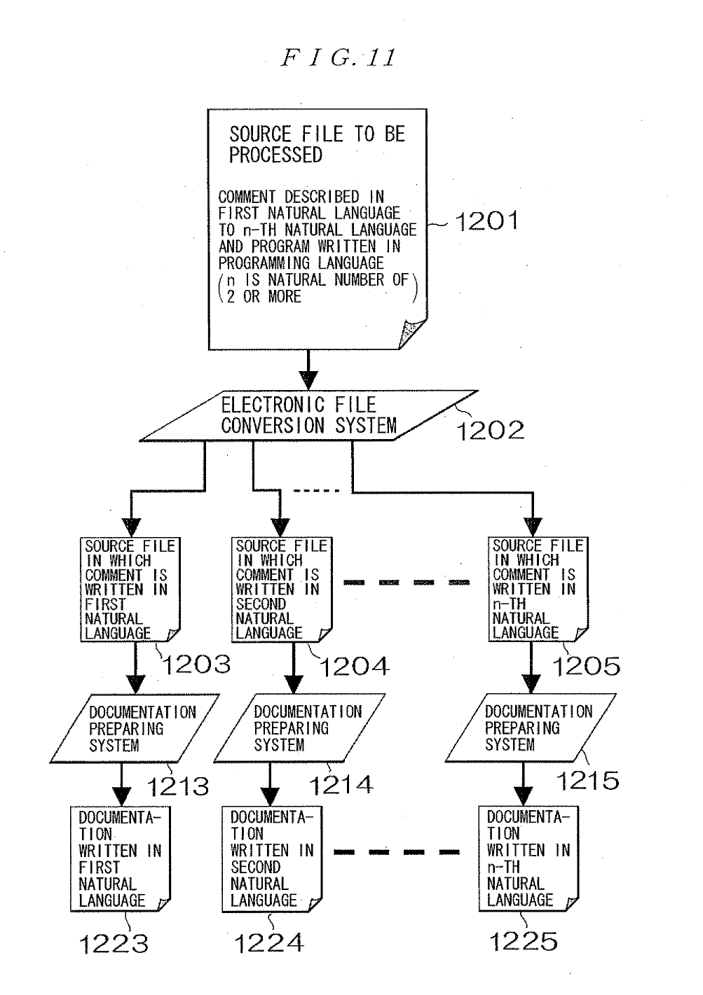

FIG. 11 shows the outline. In FIG. 11, a reference code 1201 is a source file similar to that in the above-mentioned software documentation preparing system, apparatus, or method. When a source file 1201 provided with a comment in plural natural languages is input to the electronic file conversion system 1202, and a user selects a first natural language, the source file 1203 whose comments are written in the first natural language is output. When the user selects the second natural language, a source file 1204 whose comment is written in the second natural language is output. Similarly, a source file 1205 written in the n-th natural language is output.

By inputting the output source files (1203, 1204, . . . , 1205) to the respective existing software documentation preparing systems (1213, 1214, . . . , 1215), software documentation (1223, 1224, . . . , 1225) written in target natural languages can be prepared, thereby attaining the purpose. Using the existing software documentation preparing systems means that various representation of software documentation can be realized without developing a new system by adapting the present invention. Therefore, it is a very effective system.

A source file to be input in the present invention will include a number of signs obtained by combining a sign indicating the type of a natural language and a sign indicating the meaning of a comment. When this type of file is edited on a conventional text editor, the amount of work of describing the above-mentioned combination signs increases in addition to the operation of describing a comment in each natural language, thereby causing the problem of reduced efficiency in the editing operation. Therefore, the problem can be avoided by providing a mechanism of inserting a sign for an editing system for developing software such as an existing text editor.

Assuming that a source file whose comment is described in a number of natural languages is edited on a text editor, the positions of the comment and the source code are separated on the screen as the number of types of the natural languages available increases, and the editing operation becomes difficult. Additionally, there is a risk that an editor can erroneously delete or change a part of a comment in a natural language that cannot be understood by the editor, and the editor is not aware of the error. Therefore, the problem can be avoided by providing a mechanism of presenting only a necessary natural language on the editing screen for an editing system for software development such as an existing text editor.

Practically, when a source code having comments written in a number of natural languages is edited, a description is performed in the format used for an input source file according to the present invention, and the source file is used as to be edited. The text editor can identify a comment for each natural language using a combination sign of a sign indicating the type of natural language and a sign indicating the meaning of a comment, and only a comment described in a necessary natural language can be presented to an editor. As a result, a source code whose comment is described in a number of natural languages can be edited more efficiently, thereby enhancing the quality.

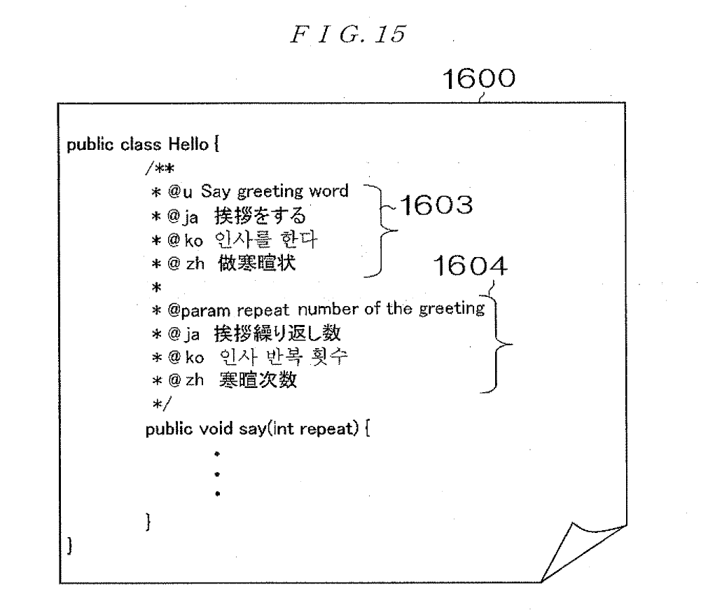

FIG. 15 shows another example of a source file structure. A source file structure used in the software documentation preparing system according to the present invention can be a source file structure in the mode as shown in FIG. 15. In a source file 1600 of the source file structure shown in FIG. 15, a comment 1603 is added as the description of the method “say” of the “class Hello”, and a comment 1604 is added as the description of the argument “param”. The data structures of the comments 1603 and 1604 are described in plural natural languages after the signs “@u” and “@param” representing the contents of the comments describing a function. In addition, the signs “@ja”, “@ko”, and “@zh” indicating the type of a natural language used in the description are added.

The software documentation preparing system according to the present invention is also useful in use of a source file of the source file structure shown in FIG. 15 as input. That is, a comment describing one of a function in the source code is described in plural natural languages following the sign indicating the function, and the comment is provided with a sign indicating the type of a natural language used in the description. Therefore, it can be effectively used when a comment in plural natural languages is additionally described. A mode for realizing the data structure as an input file can be an effective implement of the software documentation preparing system according to the present invention.

### INDUSTRIAL APPLICABILITY

According to the software documentation preparing system of the present invention, the comment and the source code written in each natural language are included in a single file, thereby being able to prepare the software documentation for each nation and area from a single source file. Holding the versions in all natural languages in a single source file means preventing the distribution of an information source, and has the effect of maintaining the consistency. Thus, the inconsistency among the natural language versions can be reduced, the time required to prepare documentation can be shortened, and the quality of the documentation can be enhanced.

In addition to preparing software documentation in each natural language, appropriate software documentation can be prepared depending on each nation or area, thereby providing each client with a higher service. Furthermore, by assigning the type of a natural language explicitly to a source code comment, a source code comment can be prepared by machine translation, which was impossible by any conventional technique. This leads to outstanding cost and time saving means when a software product is distributed to all over the world.

In selecting an appropriate statement to be translated, which is an important problem when machine translation is performed, an explicit use of a sign can reflect the intention of the software project, thereby largely contributing to the enhancement of the quality of software documentation to be prepared. A spelling check and a grammatical check have been performed on a single natural language, but by allowing a spelling check and a grammatical check to be performed on a file including plural natural languages in mixture, the quality of a comment can be improved. As for the inconsistency of a comment, which is the problem when a comment is described in plural natural languages, a portion to be corrected can also be determined efficiently by using a sign necessary to be updated. Furthermore, by using the system for converting a source file in which a comment is described in plural natural languages into a source file described in a single natural language, thereby effectively using an existing software documentation preparing system.

1. A software documentation preparing system, comprising:
input means for inputting a source file including a source code statement written in a programming language and a comment assigned to the source code statement, in which source file, the comment describing one of functions in the source code is described in plural natural languages, each of the descriptions in the natural languages provided with a combined sign of a sign indicating the function and a sign indicating a type of natural language;
storage means for interpreting the input source file, identifying the combined sign, associating the sign with a source code statement, and storing a comment on memory;
extraction means for extracting only a comment provided with a sign corresponding to the type of the user-specified natural language to be output; and
output means for outputting software documentation in the natural language to be output for the source code statement based on the extracted comment.

2. A software documentation preparing system, comprising:
input means for inputting a source file including a source code statement written in a programming language and a comment assigned to the source code statement, in which source file, the comment describing one of functions in the source code is described in plural natural languages, each of the descriptions in the natural languages provided with a combined sign of a sign indicating the function, a sign indicating a type of natural language, and a sign indicating a nation or an area;
storage means for interpreting the input source file, identifying the combined sign, associating the sign with a source code statement, and storing a comment on memory;
extraction means for extracting only a comment provided with a sign corresponding to the type of the user-specified natural language to be output; and
output means for outputting software documentation in the natural language to be output for the source code statement based on the extracted comment.

3. The software documentation preparing system according to claim 1, further comprising
translation means for translating a statement in one natural language into a statement in another natural language, wherein:
when there is no comment provided with a sign corresponding to the type of the user-specified natural language to be output, the extraction means extracts a comment provided with a sign corresponding to the type of a predetermined natural language from the source file; and
the output means allows the translation means to perform machine translation on the comment described in the predetermined natural language, and outputs software documentation in the user-specified natural language to be output.

4. The software documentation preparing system according to claim 3, wherein
a sign indicating the type of a primary natural language is included in a source file to indicate the type of the natural language of a comment to be translated as a default when the machine translation is performed.

5. The software documentation preparing system according to claim 1, wherein
a sign added to a comment includes a sign showing the necessity to update a comment, and the output means can output the information about a portion to be updated or a language to be updated in a source file based on the sign showing the necessity to update the comment.

6. A program for configuring a software documentation preparing system that outputs software documentation in plural natural languages, used to direct a computer to function as:
input means for inputting a source file including a source code statement written in a programming language and a comment assigned to the source code statement, in which source file, the comment describing one of functions in the source code is described in plural natural languages, each of the descriptions in the natural languages provided with a combined sign of a sign indicating the function and a sign indicating a type of natural language;
storage means for interpreting the input source file, identifying the combined sign, associating the sign with a source code statement, and storing a comment on memory;
extraction means for extracting only a comment provided with a sign corresponding to the type of the user-specified natural language to be output; and
output means for outputting software documentation in the natural language to be output for the source code statement based on the extracted comment.

7. A program for configuring a software documentation preparing system that outputs software documentation in plural natural languages, used to direct a computer to function as:
input means for inputting a source file including a source code statement written in a programming language and a comment assigned to the source code statement, in which source file, the comment describing one of functions in the source code is described in plural natural languages, each of the descriptions in the natural languages provided with a combined sign of a sign indicating the function, a sign indicating a type of natural language, and a sign indicating a nation or an area;
storage means for interpreting the input source file, identifying the combined sign, associating the sign with a source code statement, and storing a comment on memory;
extraction means for extracting only a comment provided with a sign corresponding to the type of the user-specified natural language to be output; and
output means for outputting software documentation in the natural language to be output for the source code statement based on the extracted comment.

8. The program according to claim 6, further comprising
a subprogram to direct the computer to further function as translation means for translating a statement in one natural language into a statement in another natural language, wherein:
the subprogram functioning as the extraction means directs the computer to function as means for extracting a comment provided with a sign corresponding to the type of a predetermined natural language from the source file when there is no comment provided with a sign corresponding to the type of the user-specified natural language to be output; and
the subprogram functioning as the output means directs the computer to function as means for allowing the translation means to perform machine translation on the comment described in the predetermined natural language, and outputting software documentation in the user-specified natural language to be output.

9. The program according to claim 6, further comprising
a sign indicating a type of primary natural language to indicate the type of natural language of a comment to be translated when machine translation is performed in a source file.

10. The program according to claim 6, wherein:
a sign provided for a comment includes a sign indicating a necessity to update a comment; and
a subprogram functioning as the output means directs a computer to function as means for outputting information about a portion to be updated in a source file or a language to be updated according to the sign about the necessity to update the comment.

11. A data structure of a source file, wherein
in a source file including a source code statement written in a programming language and a comment assigned to the source code statement, a comment describing one of a function in a source code is described in plural natural languages, and a combined sign of a sign indicating a function and a sign indicating the type of a natural language is provided for a description of each natural language.

12. A data structure of a source file, wherein
in a source file including a source code statement written in a programming language and a comment assigned to the source code statement, a comment describing one of a function in a source code is described in plural natural languages following the sign indicating a function, and a sign of the type indicating the natural language used in the description is added to the comment.
